(19) United States
(12) Patent Application Publication
(10) Pub. No.: US 2018/0032912 A1
(43) Pub. Date: Feb. 1, 2018

(54) DATA PROCESSING METHOD, AND DATA PROCESSING APPARATUS

(71) Applicant: KDDI CORPORATION, Tokyo (JP)

(72) Inventors: Kazunori Matsumoto, Fujimino-shi (JP); Keiichiro Hoashi, Fujimino-shi (JP)

(21) Appl. No.: 15/658,993

(22) Filed: Jul. 25, 2017

(30) Foreign Application Priority Data
Jul. 29, 2016 (JP) 2016-150717

(51) Int. Cl. G06N 99/00; G06K 9/62

(52) U.S. Cl. CPC G06N 99/005; G06K 9/6269

(57) ABSTRACT

A data processing method, includes: mapping each of a plurality of data, for which classes the data belong to are known, to one point on an N-dimensional feature space using at least two feature amounts; dividing a set of points corresponding to the plurality of data mapped on the feature space into a plurality of N-dimensional simplexes having each point as an apex; classifying a set of points that constitute a hyperplane of each simplex obtained by the division into a subset including points that belong to the same class as elements; and reducing the elements of the subsets for each of the classified subsets. The dividing includes dividing the set of points into the plurality of simplexes so a hypersphere circumscribed on each simplex does not include a point that constitutes another simplex.

### CROSS-REFERENCE TO RELATED APPLICATION

This application is based upon and claims the benefit of priority from the prior Japanese Patent Application No. 2016-150717, filed on Jul. 29, 2016, the entire contents of which are incorporated herein by reference.

### BACKGROUND OF THE INVENTION

### Field of the Invention

The present invention relates to a data processing method, a data processing apparatus, and a computer readable medium and, more particularly, to a technique of reducing data used in machine learning.

### Description of the Related Art

In recent years, supervised machine learning methods such as a neural network, support vector machine, and boosting have rapidly been developed. These machine learning methods generally tend to obtain a learning result of high generalization capability as the number of training data used in leaning increases. On the other hand, as the number of training data used in leaning increases, the time needed for the learning increases. For this reason, Japanese Patent No. 5291478 proposes a method of repetitively performing a procedure of selecting a plurality of training data to be used in a support vector machine and obtaining one optimum training vector from them, thereby reducing the training data.

For each training data used in a supervised machine learning method, a class to which the training data belongs is defined. The supervised machine learning can also be called a procedure of defining a criterion used to discriminate the class of given training data. Hence, reducing training data is equivalent to changing training data, and may therefore greatly affect generation of the criterion by supervised machine learning. With this as a backdrop, it is demanded to raise the appropriateness of reduction of training data.

### SUMMARY OF THE INVENTION

According to an aspect of the present invention, there is provided a data processing method executed by a processor, comprising mapping each of a plurality of data, for which the classes the data belong to are known, to one point on an N-dimensional (N is an integer of not less than 2 or infinity) feature space using at least two feature amounts, dividing a set of points corresponding to the plurality of data mapped on the feature space into a plurality of N-dimensional simplexes having each point as an apex, classifying a set of points that constitute a hyperplane of each simplex obtained by the division into a subset including points that belong to the same class as elements, and reducing the elements of the subsets for each of the classified subsets, wherein the dividing comprises dividing the set of points into the plurality of simplexes so a hypersphere circumscribed on each simplex does not include a point that constitutes another simplex.

Further features of the present invention will become apparent from the following description of exemplary embodiments with reference to the attached drawings.

### BRIEF DESCRIPTION OF THE DRAWINGS

FIG. 1 is a block diagram schematically showing the functional arrangement of a data processing apparatus according to an embodiment;

FIGS. 2A to 2D are views for explaining known data reduction processing executed by the data processing apparatus according to the embodiment;

FIG. 3 is a view for explaining reduction processing executed by a data reduction unit according to the embodiment;

FIG. 4 is another view for explaining reduction processing executed by the data reduction unit according to the embodiment; and

FIG. 5 is a flowchart for explaining data reduction processing executed by the data processing apparatus according to the embodiment.

### DESCRIPTION OF THE EMBODIMENTS

<Outline of Support Vector Machine>

As for machine learning that is the premise of a data processing technique according to an embodiment, the outline will be described first using a support vector machine (to be referred to as “SVM” hereinafter) as an example.

SVM is a kind of supervised machine learning, which is a method of generating discriminators of two classes using a linear input element. The main task of SVM is to solve the constrained quadratic programing problem (QP problem) of equation (1) when one training data xi (where i=1, 2, . . . , 1) having a label yi of −1 or +1 is given. Note that the training data xi having the label yi of −1 and the training data xi having the label yi of +1 correspond to the above-described data of two classes.

$${min}_{α} L ( α ) = \frac{1}{2} {\sum }_{i , j = 1}^{l} {y}_{i} {y}_{j} {α}_{i} {α}_{j} K ( {x}_{i} , {x}_{j} ) - {\sum }_{i = 1}^{l} {α}_{i} \\ subject to \\ {\sum }_{i = 1}^{l} {y}_{i} {α}_{i} = 0 \\ 0 \leq {α}_{i} \leq {C}_{i} ( i = 1 , … , l ) \qquad ( 1 )$$

Each element of training data is mapped to one point on a multidimensional feature space by a plurality of feature amounts. For this reason, each training data can be specified using a position vector xᵢ on the feature space. Hence, each element of training data will be referred to using the position vector xᵢ on the feature space hereinafter. That is, if given training data is mapped to the position vector xᵢ on the feature space, the training data will be expressed as “vector xᵢ”.

K(xᵢ, xⱼ) in equation (1) is a kernel function that calculates the inner product between two vectors xᵢ and xⱼ on the feature space, and Cᵢ (i=1, 2, . . . , l) is a parameter for giving a penalty to training data with noise out of the given training data.

In solving the above-described problem, if the number 1 of training data is large, the following three problems arise.

1) A problem of the capacity of a memory for storing kernel matrix Kᵢⱼ=K(xᵢ, xⱼ), (where i, j=1, 2, . . . , l). That is, the problem of the data amount of a kernel matrix more than the normal memory capacity of a computer.

2) A problem of complex calculation of the kernel value Kᵢⱼ (i, j=1, 2, . . . , l) by the computer.

3) A problem of complex solution of the QP problem by the computer.

In a test phase, that is, in a phase in which the class of unknown data x is verified using an identifier generated using teacher data, a decision function ƒ(x) of SVM is expressed by

$$f ( x ) = {\sum }_{i = 1}^{Ns} {α}_{i} K ( {x}_{i} , x ) + b \qquad ( 2 )$$

and is formed from data selected from Ns training data xᵢ (i=1, 2, . . . , Ns) called support vectors.

In equation (2), if ƒ(x)>0, the unknown data x is classified into a class of a positive label. Similarly, if ƒ(x)<0, the unknown data x is classified into a class of a negative label.

The complexity of the decision function ƒ(x) of SVM in equation (2) linearly increases along with an increase in the number Ns of support vectors. If the number of support vectors increases, the calculation speed of SVM in the test phase decreases because the calculation amount of the kernel value K(xᵢ, x) (i=1, 2, . . . , Ns) increases.

In summary, if the number 1 of training data increase, the time needed for training to generate discriminators increases. If the number of support vectors that are obtained as discriminators increases, the time needed for discrimination of unknown data in the test phase increases.

Concerning each of a plurality of data prepared as training data, the class to which the data belongs, that is, the value of the above-described label yᵢ is known. Also for each of one or more support vectors selected from the training data by the learning method of SVM, the class to which the support vector belongs is known. This is because a support vector is data selected from a plurality of training data for which the classes the data belong to are known. Hence, data for which the class the data belongs is known will simply be referred to as “known data” in this specification except a case in which training data and a support vector that is a discriminator are particularly discriminated.

Japanese Patent No. 5291478 proposes a method of reducing N training data to M (M<<N) training data called reduced vectors to speed up the calculation of SVM. Since both training data and support vectors are known data, the reduction method is applicable to reduction of support vectors as well.

On the other hand, since reduction of training data may greatly affect generation of a criterion (a support vector in SVM) by supervised machine learning, it is preferable to raise the appropriateness of reduction of training data.

### Outline of Embodiment

A data processing method according to the embodiment is directed to a method of selecting known data as reduction targets when reducing known data including training data and support vectors. A data processing apparatus according to the embodiment maps each known data to a point on a feature space and executes Delaunay triangulation for the mapped point group on a multidimensional space.

“Delaunay triangulation” is a kind of method of wholly dividing a two-dimensional plane without overlap by triangles having apexes at points discretely distributed on the two-dimensional plane. Triangles divided by Delaunay triangulation have a characteristic to be described below. That is, a circle circumscribed on an arbitrary triangle divided by Delaunay triangulation does not include a point that constitutes another triangle.

Delaunay triangulation is known to be extendable to a space division method for a point group on a multidimensional space with three or more dimensions. In the extended Delaunay triangulation, a multidimensional space is divided by simplexes having apexes at points discretely distributed on the multidimensional space.

For example, a simplex in a three-dimensional space is a tetrahedron. Hence, in Delaunay triangulation of a three-dimensional space, the three-dimensional space is divided by tetrahedrons having apexes at points discretely distributed on the three-dimensional space. When Delaunay triangulation is executed in a three-dimensional space, a sphere circumscribed on an arbitrary tetrahedron does not include a point that constitutes another tetrahedron.

Similarly, a simplex in a four-dimensional space is a 5-cell. Hence, in Delaunay triangulation of a four-dimensional space, the four-dimensional space is divided by 5-cells having apexes at points discretely distributed on the four-dimensional space. When Delaunay triangulation is executed in a four-dimensional space, a sphere circumscribed on an arbitrary 5-cell does not include a point that constitutes another 5-cell.

Note that a “hyperplane” in a tetrahedron is a triangle, and a hyperplane in a 5-cell is a tetrahedron. In general, a hyperplane that constitutes an N-dimensional simplex is an (N−1)-dimensional simplex.

As described above, properly speaking, Delaunay triangulation for a point group on a multidimensional space with three or more dimensions is “simplex division”. In this specification, division of a multidimensional space with two or more dimensions will simply be referred to as “Delaunay division” for the descriptive convenience, and a simplex of two or more dimensions obtained by Delaunay division will simply be referred to as a “simplex”. As for an arbitrary simplex obtained by executing Delaunay division, a hypersphere circumscribed on the simplex does not include a point that constitutes another simplex. This characteristic is a broad characteristic that holds over the entirety of a space on which known data are distributed.

The data processing apparatus according to the embodiment selects, as a reduction target, the hyperplane of each simplex obtained by executing multidimensional Delaunay division for known data discretely distributed on a feature space. The data processing apparatus according to the embodiment classifies the known data distributed on the feature space using Delaunay division and then executes reduction. For this reason, it is possible to incorporate not simple local information such as the distance between two known data on a feature space but the broad characteristic of Delaunay division in reduction. It is therefore considered that the appropriateness of reduction processing of data used in the machine learning method rises.

The data processing apparatus according to the embodiment will be described below in more detail. Note that a data processing apparatus 1 is assumed below to execute machine learning using the SVM method.

<Functional Arrangement of Data Processing Apparatus>

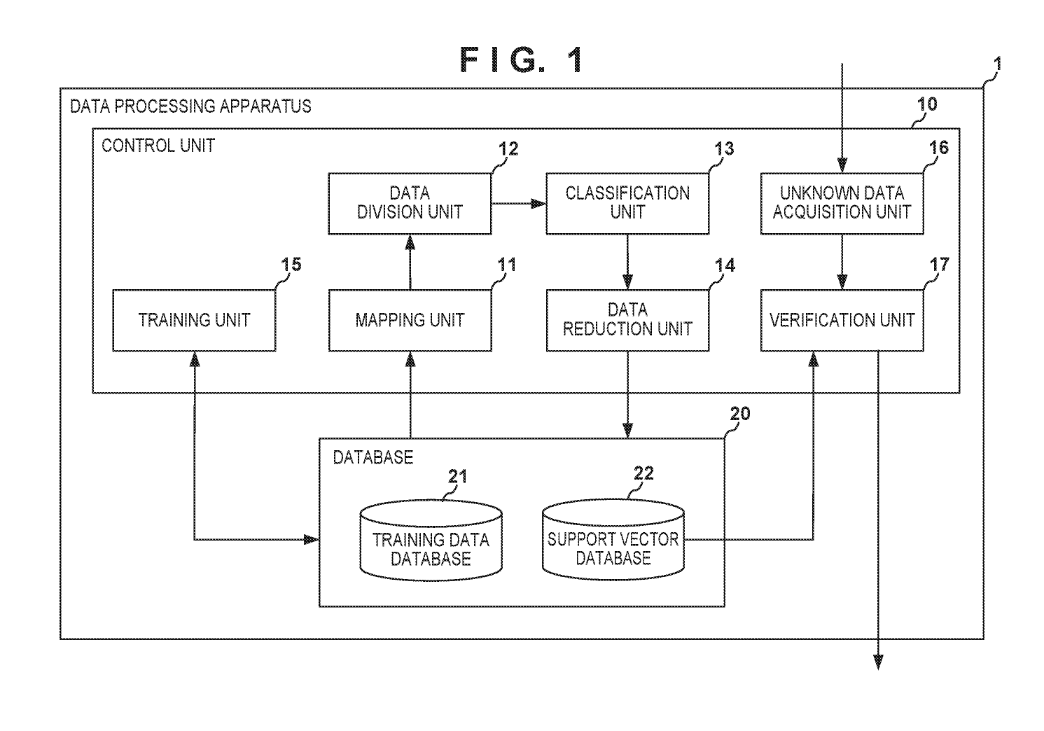

FIG. 1 is a block diagram schematically showing the functional arrangement of the data processing apparatus 1 according to the embodiment. The data processing apparatus 1 according to the embodiment includes a control unit 10 and a database 20. The control unit 10 includes a mapping unit 11, a data division unit 12, a classification unit 13, a data reduction unit 14, a training unit 15, an unknown data acquisition unit 16, and a verification unit 17. The database 20 includes a training data database 21 and a support vector database 22.

The control unit 10 is a computer, for example, a PC (Personal Computer) or server including calculation resources such as a CPU (Central Processing Unit) and memories. The control unit 10 executes a computer program and thus functions as the mapping unit 11, the data division unit 12, the classification unit 13, the data reduction unit 14, the training unit 15, the unknown data acquisition unit 16, and the verification unit 17.

The database 20 is a known mass storage device, for example, an HDD (Hard Disc Drive) or SSD (Solid State Drive). Both the training data database 21 and the support vector database 22 included in the database 20 are databases for storing a plurality of known data.

More specifically, the training data database 21 stores a plurality of training data for which the classes the data belong to are known. The support vector database 22 stores support vectors generated from the training data using SVM. The database 20 also stores an operating system configured to control the data processing apparatus 1, a computer program configured to cause the control unit 10 to implement the function of each unit, and a plurality of feature amounts to be used in SVM.

The mapping unit 11 maps each of the plurality of known data stored in the database 20 to one point on an N-dimensional feature space using two or more feature amounts. Here, N is an integer of 2 or more or infinity, and changes depending on the type of K(xᵢ, xⱼ) in equation (1).

The data division unit 12 divides a set of points corresponding to the plurality of data mapped on the feature space by the mapping unit 11 into a plurality of N-dimensional simplexes having each point as an apex using the Delaunay division method. More specifically, the data division unit 12 divides the point group into a plurality of simplexes so a hypersphere circumscribed on each simplex does not include a point that constitutes another simplex.

The classification unit 13 classifies a set of points that constitute the hyperplane of each simplex obtained by Delaunay division executed by the data division unit 12 into a subset including points that belong to the same class as elements. The data reduction unit 14 reduces the elements of each subset classified by the classification unit 13.

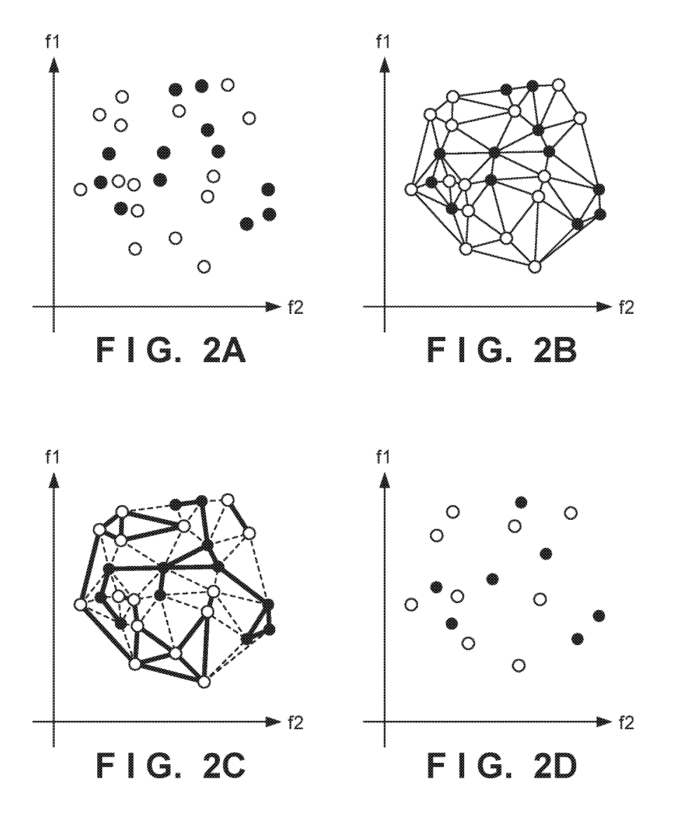

FIGS. 2A to 2D are views for explaining known data reduction processing executed by the data processing apparatus 1 according to the embodiment. Note that for the illustrative convenience, FIGS. 2A to 2D show an example in which known data are mapped on a two-dimensional feature space spanned by two feature amounts, that is, feature amounts f1 and f2. However, the number of dimensions of a feature space is generally larger than 2.

FIG. 2A is a view schematically showing a feature space in a case in which the mapping unit 11 maps known data on a two-dimensional feature space using the feature amounts f1 and f2. In FIG. 2A, an open circle represents known data with a positive label, that is, a value yᵢ of +1. In FIG. 2A, a full circle represents known data with a negative label, that is, the value yᵢ of −1.

FIG. 2B is a view showing a result of Delaunay division executed by the data division unit 12 for the point group shown in FIG. 2A. As shown in FIG. 2B, the data division unit 12 executes Delaunay division without discriminating each point by the value of its label. For this reason, as shown in FIG. 2B, the sides of simplexes (triangles in FIG. 2B) include three types of sides, that is, a side with open circles at two ends, a side with full circles at two ends, and a side with an open circle at one end and a full circle at the other end.

Note that a side in a two-dimensional simplex corresponds to a hyperplane in a multidimensional simplex. Like the two-dimensional simplex, the hyperplanes of multidimensional simplexes include three types of hyperplanes, that is, a hyperplane formed from only points corresponding to data of a positive label, a hyperplane formed from only points corresponding to data of a negative label, and a hyperplane including both points.

FIG. 2C is a view showing a result of classification performed by the classification unit 13 for the hyperplanes (that is, the sides of the triangles) of the simplexes shown in FIG. 2B. The classification unit 13 selects, of the sides of the triangles shown in FIG. 2B, sides each having the points of the same class at the two ends, thereby classifying the points into two subsets. In FIG. 2C, the sides each having an open circle at one of the two ends and a full circle at the other end are indicated by broken lines as sides that are not selected by the classification unit 13.

FIG. 2D is a view showing a result of reduction executed by the data reduction unit 14 based on the selection result shown in FIG. 2C. The number of data shown in FIG. 2D is smaller than the number of data shown in FIG. 2A. Using the data set shown in FIG. 2D, the data processing apparatus 1 can increase the execution speed of training or test of SVM.

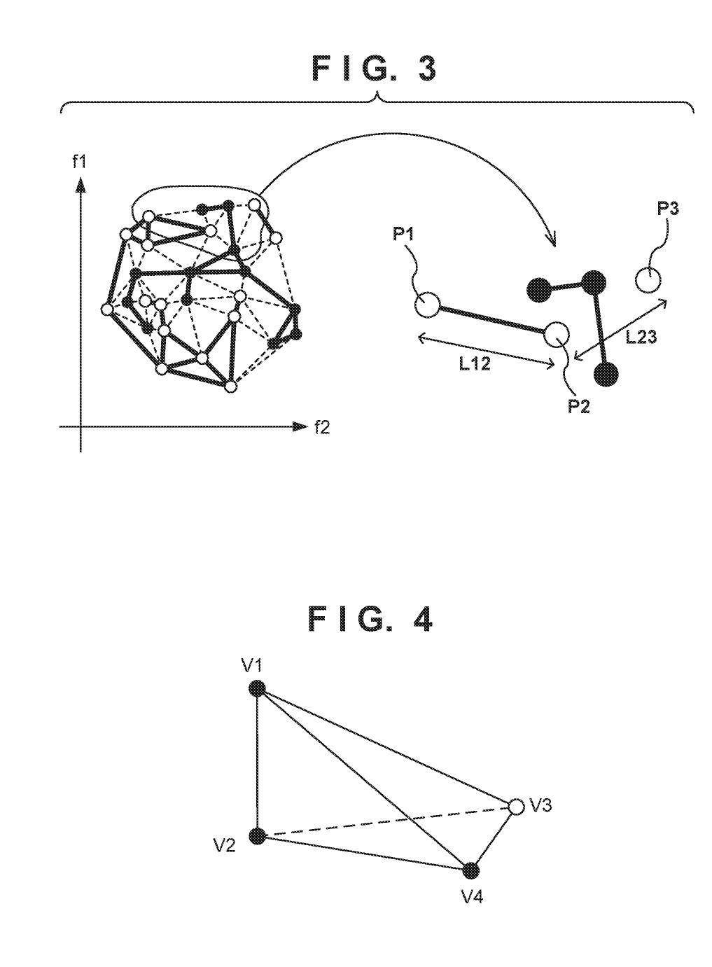

FIG. 3 is a view for explaining reduction processing executed by the data reduction unit 14 according to the embodiment. FIG. 3 is a view showing FIG. 2C and an enlarged part thereof.

The data reduction unit 14 reduces, of the elements constituting each of the subsets classified by the classification unit 13, two elements having the minimum Euclidean distance on the feature space into one new element. For example, in the example shown in FIG. 3, a distance L12 between a point P1 and a point P2 is longer than a distance L23 between the point P2 and a point P3. However, since the points P2 and P3 are not points that constitute the same simplex, the data reduction unit 14 does not select the points P2 and P3 as the reduction targets. Hence, the new data group generated as the result of reduction is different from that in a conventional method that decides the reduction targets simply based on the Euclidean distance between two points.

FIG. 4 is another view for explaining reduction processing executed by the data reduction unit 14 according to the embodiment. More specifically, FIG. 4 is a view for explaining the unit of reduction processing of the data reduction unit 14 in a case in which the feature space is a four-dimensional space. If the feature space is a four-dimensional space, the simplex is a 5-cell, and its hyperside is a tetrahedron as shown in FIG. 4.

The tetrahedron as the hyperside of the simplex shown in FIG. 4 is a tetrahedron having a point V1, a point V2, a point V3, and a point V4 as the apexes. Of the points, the points V1, V2, and V4 are full circles (the value of the label is negative), and the point V3 is an open circle (the value of the label is positive). In this case, the classification unit 13 classifies the points V1, V2, and V4 into a subset of points having the negative label, and classifies the point V3 into a subset of points having the positive label. In this example, since only the point V3 is included as an element in the subset of points having the positive label, the data reduction unit 14 does not select the point as the reduction target.

Since the subset having the positive label includes a plurality of points, the points are selected as the targets of reduction processing by the data reduction unit 14. In FIG. 4, let L12 be the distance between the point V1 and the point V2, L24 be the distance between the point V2 and the point V4, and L41 be the distance between the point V4 and the point V1. Then, L12<L24<L41 holds. Hence, the data reduction unit 14 generates one new point by reducing the points V1 and V2. Note that as a detailed method of reduction, a known method is used.

The data reduction unit 14 sets the class of the new element obtained by reduction to the same class as the class to which the two elements of the reduction targets belong. In the example shown in FIG. 4, since both the point V1 and the point V2 are points having the negative label, the data reduction unit 14 adds the negative label to the new element obtained by the reduction as well. While referring to the subsets classified by the classification unit 13, the data reduction unit 14 executes the reduction processing for the hypersides of all simplexes divided by the data division unit 12, thereby generating a new data set. The data reduction unit 14 stores the generated new data set in the training data database 21.

Note that in FIG. 4, L34 that is the distance between the point V3 and the point V4 is shorter than L12, L24, and L41. That is, this side is the shortest of the sides constituting the tetrahedron shown in FIG. 4. However, since the points V3 and V4 have different labels and are therefore classified into different subsets, the data reduction unit 14 does not reduce the points V3 and V4 into a new element.

The data division unit 12 executes Delaunay division again for the new data set. The classification unit 13 reclassifies a set of points that constitute the hyperplane of each simplex obtained by Delaunay division executed again by the data division unit 12 into a subset including points of the same class as elements. While referring to the subsets reclassified by the classification unit 13, the data reduction unit 14 executes the reduction processing again for the hypersides of all simplexes newly divided by the data division unit 12, thereby generating a new data set. The data processing apparatus 1 can decrease the number of known data by repeating the above-described processing.

Referring back to FIG. 1, the training unit 15 executes SVM for training data stored in the training data database 21, thereby generating a support vector as a discriminator configured to discriminate the class to which arbitrary data belongs. The training unit 15 stores the generated support vector in the support vector database 22.

The unknown data acquisition unit 16 acquires unknown data for which the class the data belongs to is unknown. The verification unit 17 applies the discriminator generated by the training unit 15 to the unknown data acquired by the unknown data acquisition unit 16, thereby discriminating the class of the unknown data.

When executing reduction processing for training data stored in the training data database 21 as known data, the data processing apparatus 1 can decrease the number of training data as the SVM execution targets. In this case, since the data processing apparatus 1 can decrease the calculation amount needed for training, the training can be speeded up.

On the other hand, when executing reduction processing for support vectors stored in the support vector database 22 as known data, the data processing apparatus 1 can decrease the number of support vectors. In this case, since the data processing apparatus 1 can decrease the calculation amount needed for test processing that is processing of discriminating the class of unknown data, the test processing can be speeded up.

<Processing Procedure of Data Reduction Processing>

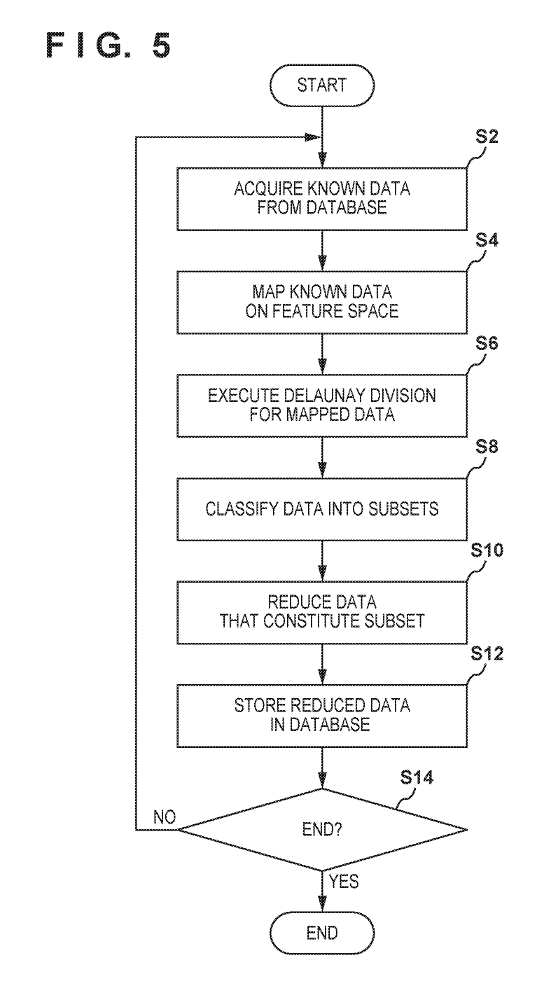

FIG. 5 is a flowchart for explaining the procedure of data reduction processing executed by the data processing apparatus 1 according to the embodiment. The processing of this flowchart starts when, for example, the data processing apparatus 1 is powered on.

In step S2, the mapping unit 11 acquires known data from the database 20. In step S4, the mapping unit 11 maps each known data to one point on the feature space. In step S6, the data division unit 12 executes Delaunay division for the point group of known data mapped on the feature space by the mapping unit 11.

In step S8, the classification unit 13 classifies points that constitute the hyperplanes of a plurality of simplexes obtained by the Delaunay division into subsets for each class to which corresponding data belongs. In step S10, for each of the classified subsets, the data reduction unit 14 reduces data that constitute the subset. In step S12, the data division unit 12 stores new known data obtained by the reduction in the database 20.

Until the iteration count reaches a predetermined count, the data processing apparatus 1 does not end the reduction processing (NO in step S14), and continues each of the above-described processes. If the data processing apparatus 1 executes the reduction processing as many times as the predetermined iteration count (YES in step S14), the processing of this flowchart ends.

As described above, according to the data processing apparatus 1 of the embodiment, it is possible to raise the appropriateness of reduction processing of data used in the supervised machine learning method.

In particular, when the data processing apparatus 1 executes reduction processing for training data, the time needed for machine learning can be shortened. In addition, when the data processing apparatus 1 executes reduction processing for support vectors, the time needed for the test phase for discriminating the class of unknown data can be shortened.

The present invention has been described above using the embodiment. However, the present invention is not limited to the technical scope described in the embodiment. Various modifications or improvements can be made for the embodiment, as is apparent to those skilled in the art. In particular, a detailed embodiment of distribution/integration of devices is not limited to that illustrated, and all or some of the devices can be functionally or physically distributed/integrated in an arbitrary unit in accordance with various additions or a functional load.

For example, in the above example, SVM has mainly been exemplified as machine learning. However, training data reduction can also be applied to another machine learning method other than SVM, for example, a neural network or boosting.

In the above-described example, the data division unit 12 executes Delaunay triangulation for data mapped on the feature space. As the duality of Delaunay triangulation, there exists a Voronoi diagram. More specifically, a division diagram obtained by Delaunay triangulation represents the adjacent relationship of Voronoi regions. Hence, executing Delaunay triangulation and obtaining a Voronoi diagram have a one-to-one relationship. In this sense, the data division unit 12 may obtain a Voronoi diagram instead of executing Delaunay triangulation for data mapped on the feature space.

What is claimed is:

1. A data processing method executed by a processor, comprising:
mapping each of a plurality of data, for which classes the data belong to are known, to one point on an N-dimensional (N is an integer of not less than 2 or infinity) feature space using at least two feature amounts;
dividing a set of points corresponding to the plurality of data mapped on the feature space into a plurality of N-dimensional simplexes having each point as an apex;
classifying a set of points that constitute a hyperplane of each simplex obtained by the division into a subset including points that belong to the same class as elements; and
reducing the elements of the subsets for each of the classified subsets,
wherein the dividing comprises dividing the set of points into the plurality of simplexes so a hypersphere circumscribed on each simplex does not include a point that constitutes another simplex.

2. The method according to claim 1, wherein the reducing comprises reducing, of the elements constituting each of the classified subsets, two elements having a minimum Euclidean distance on the feature space into one new element.

3. The method according to claim 2, wherein the reducing further comprises:
setting a class of the new element obtained by the reduction to the same class as a class to which the two elements of reduction targets belong; and
repeating the dividing, the classifying, and the reducing for a plurality of data including the new element obtained by the reducing.

4. The method according to claim 1, further comprising generating a discriminator configured to discriminate a class to which arbitrary data belongs by performing machine learning of the reduced data.

5. The method according to claim 4, wherein the generating comprises performing the machine learning using a support vector machine.

6. The method according to claim 1, wherein the mapping comprises mapping, as the plurality of data, a plurality of support vectors that are data selected by machine learning using a support vector machine from a plurality of training data for which the classes the data belong to are known.

7. A data processing apparatus comprising:
a database configured to store a plurality of data for which the classes the data belong to are known;
a mapping unit configured to map each of the plurality of data to one point on an N-dimensional (N is an integer of not less than 2 or infinity) feature space using at least two feature amounts;
a data division unit configured to divide a set of points corresponding to the plurality of data mapped on the feature space into a plurality of N-dimensional simplexes having each point as an apex;
a classification unit configured to classify a set of points that constitute a hyperplane of each simplex obtained by the division into a subset including points that belong to the same class as elements; and
a data reduction unit configured to reduce the elements of the subsets for each of the classified subsets,
wherein the data division unit is further configured to divide the set of points into the plurality of simplexes so a hypersphere circumscribed on each simplex does not include a point that constitutes another simplex.

8. A non-transitory computer-readable storage medium storing a computer program,
the computer program, executed by at least processor of an apparatus, comprising:
an instruction to cause the apparatus to map each of a plurality of data, for which the classes that the data belong to are known, to one point on an N-dimensional (N is an integer of not less than 2 or infinity) feature space using at least two feature amounts;
an instruction to cause the apparatus to divide a set of points corresponding to the plurality of data mapped on the feature space into a plurality of N-dimensional simplexes having each point as an apex;
an instruction to cause the apparatus to classify a set of points that constitute a hyperplane of each simplex obtained by the division into a subset including points that belong to the same class as elements; and
an instruction to cause the apparatus to reduce the elements of the subsets for each of the classified subsets,
wherein the instruction to cause the apparatus to divide further causes the apparatus to divide the set of points into the plurality of simplexes so a hypersphere circumscribed on each simplex does not include a point that constitutes another simplex.
